(19) United States
(12) Patent Application Publication
(10) Pub. No.: US 2016/0352108 A1
(43) Pub. Date: Dec. 1, 2016

(54) ELECTRONIC APPARATUS, POWER SUPPLY CONTROL DEVICE, AND POWER SUPPLY SYSTEM

(71) Applicant: FUJITSU LIMITED, Kawasaki-shi (JP)

(72) Inventor: Shigeaki NAKAZAWA, Kawasaki (JP)

(73) Assignee: FUJITSU LIMITED, Kawasaki-shi (JP)

(21) Appl. No.: 15/167,852

(22) Filed: May 27, 2016

(30) Foreign Application Priority Data
Jun. 1, 2015 (JP) 2015-111019

(51) Int. Cl. H02J 7/00

(52) U.S. Cl. CPC H02J 7/007; H02J 7/0045

(57) ABSTRACT

An electronic apparatus includes: a battery that is charged with power supplied from a power supply adaptor; a load unit that is arranged on a supply path through which power is supplied from the power supply adaptor and the battery; and a power supply control unit that detects a load of the load unit and output a control signal which causes the power supply adaptor to change an output voltage based on the load.

### CROSS-REFERENCE TO RELATED APPLICATION

This application is based upon and claims the benefit of priority of the prior Japanese Patent Application No. 2015-111019, filed on Jun. 1, 2015, the entire contents of which are incorporated herein by reference.

### FIELD

The embodiments discussed herein are related to an electronic apparatus, a power supply control device, and a power supply system.

### BACKGROUND

A portable electronic apparatus employs a power supply system in which a system power supply receives power from an alternating current (AC) adaptor or a battery and the received power is then supplied from the system power supply to devices in the portable electronic apparatus. A majority of such electronic apparatuses charge the battery via a charging circuit using the AC adaptor.

Such a system power supply has a wide input voltage range (for example, 7.5 V to 21 V) in order to receive power from both of the AC adaptor and the battery. Accordingly, recently, the power supply system increasingly employs a configuration in which an input voltage from the AC adaptor is received by the system power supply after being lowered to be approximately equal to an input voltage of the battery in the charging circuit. Accordingly, in the power supply system, the charging circuit is responsible for supplying power to the system power supply and for supplying charging power to the battery.

On the other hand, there is a demand for miniaturization of the portable electronic apparatus and there is a solution that meets the demand for the miniaturization of the portable electronic apparatus in which the charging circuit is built into the AC adaptor. In such a power supply system, since a large change does not occur in a power component, even if a charge control unit is added to an output control circuit of the AC adaptor, the influence given to a size of the AC adaptor is small. In the power supply system, since the most recent battery voltage is measured during charging and the measured voltage is fed back to the AC adaptor, it is possible to improve the accuracy of the charging voltage supplied to the battery.

However, there is a demand for extending a driving time during which a load unit is driven using the battery as a power supply in the electronic apparatus and the electronic apparatus is provided with a standby state to reduce power consumption in order to respond to the demand. Such an electronic apparatus has a tendency that variation of the power consumption is severe in the load unit and the input voltage to the load unit is suddenly changed.

The AC adaptor includes an output capacitor having a large capacity in order to handle instantaneous interruption or an instantaneous drop that occurs in the commercial power supply. Accordingly, the load response of the AC adaptor is slower than that of the system power supply. The AC adaptor has low responsiveness to the voltage variation. Therefore, in the output control in the AC adaptor, a sharp variation of the input voltage to the load unit raises the voltage applied to the battery, thereby a load imposed on the battery is increased.

The following is a reference document.

[Document 1] Japanese Laid-open Patent Publication No. 2001-211564.

### SUMMARY

According to an aspect of the invention, an electronic apparatus includes: a battery that is charged with power supplied from a power supply adaptor; a load unit that is arranged on a supply path through which power is supplied from the power supply adaptor and the battery; and a power supply control unit that detects a load of the load unit and output a control signal which causes the power supply adaptor to change an output voltage based on the load.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a power supply system according to a first embodiment;

FIG. 2 is a diagram illustrating an example of a power supply system according to a second embodiment;

FIG. 3 is a diagram illustrating an example of a circuit configuration of an AC adaptor according to the second embodiment;

FIG. 4 is a diagram illustrating an example of a circuit configuration of a PC body according to the second embodiment;

FIG. 5 is a diagram illustrating an example of a circuit configuration of an AC adaptor control circuit according to the second embodiment;

FIG. 6 is a diagram illustrating an example of a circuit configuration of an error amplifier for system load according to the second embodiment;

FIG. 7 is a diagram illustrating an example of an output waveform of each circuit component in the error amplifier for system load when system load information which is suddenly changed and has large variation is input according to the second embodiment;

FIG. 8 is a diagram illustrating an example of an output waveform of each circuit component in the error amplifier for system load when system load information which is smoothly changed and has large variation is input according to the second embodiment;

FIG. 9 is a diagram illustrating an example of an output waveform of each circuit component in the error amplifier for system load when system load information which is suddenly changed and has small variation is input according to the second embodiment;

FIG. 10 is a diagram illustrating an example of a circuit configuration of an oscillation/control circuit provided in the AC adaptor according to the second embodiment; and

FIG. 11 is a diagram illustrating comparison examples for a case of the presence or the absence of system load information for a waveform of an output voltage of the AC adaptor and a waveform of an input voltage of the system power supply.

### DESCRIPTION OF EMBODIMENTS

Hereinafter, embodiments of the present disclosure will be described in detail with reference to the accompanying drawings.

### First Embodiment

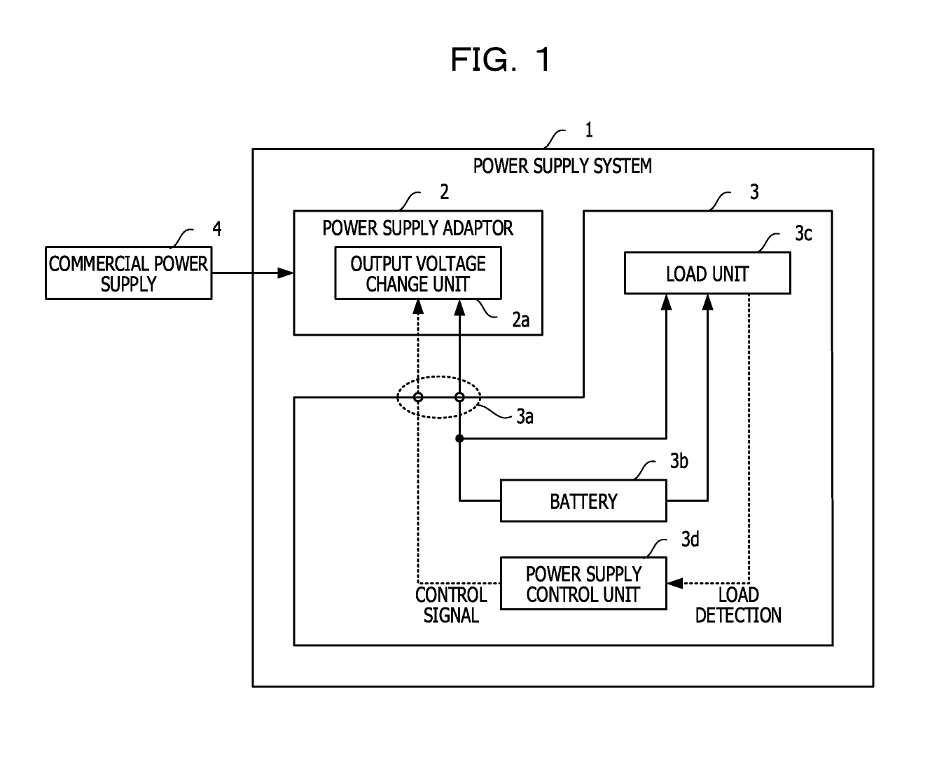

First, a power supply system according to a first embodiment will be described with reference to FIG. 1. FIG. 1 is a diagram illustrating an example of a power supply system according to a first embodiment.

A power supply system 1 includes a power supply adaptor 2 and an electronic apparatus 3. For example, the power supply adaptor 2 is an AC adaptor and the electronic apparatus is a portable apparatus such as a notebook Personal Computer (PC). The power supply adaptor 2 converts alternating current supplied from a commercial power supply 4 into direct current. The electronic apparatus 3 is able to electrically couple to the power supply adaptor 2 using a connection unit 3a and consumes direct current supplied from the power supply adaptor 2.

The electronic apparatus 3 includes a battery 3b, a load unit 3c, and a power supply control unit 3d. The load unit 3c receives the power supplied from the power supply adaptor 2 or the battery 3b. The battery 3b is charged with the power supplied from the power supply adaptor 2. The battery 3b is, for example, a lithium ion battery or the like. The battery 3b may supply the charged power to the load unit 3c. The load unit 3c consumes the power supplied by the power supply adaptor 2 or the battery 3b. The load unit 3c is arranged on a supply path to which the power is supplied from the power supply adaptor 2 and the battery 3b.

The power supply control unit 3d detects a load of the load unit 3c. For example, the power supply control unit 3d detects the current flowing in the load unit 3c as the load of the load unit 3c. The power supply control unit 3d outputs a control signal based on the detected load. The control signal is a signal which causes the power supply adaptor 2 to change an output voltage. For example, the power supply control unit 3d outputs the control signal using a voltage level.

The power supply adaptor 2 includes an output voltage change unit 2a. The output voltage change unit 2a changes the output power to the electronic apparatus 3 based on a control signal input from the power supply control unit 3d.

In this way, the power supply system 1 detects a load imposed on the load unit 3c and immediately outputs the control signal to the power supply adaptor 2, and thus, the response of the power supply adaptor 2 is rapid. Therefore, the power supply system 1 achieves power supply control capable of changing the output voltage at high speed compared to power supply control which is performed by detecting the output voltage of the power supply adaptor 2.

With this, the power supply system 1 suppresses a variation width of the output voltage of the power supply adaptor 2 based on a load variation of the load unit 3c, and may improve the accuracy of a voltage across the battery 3b. Accordingly, the power supply system 1 may reduce a load due to the variation of the voltage across the battery 3b.

### Second Embodiment

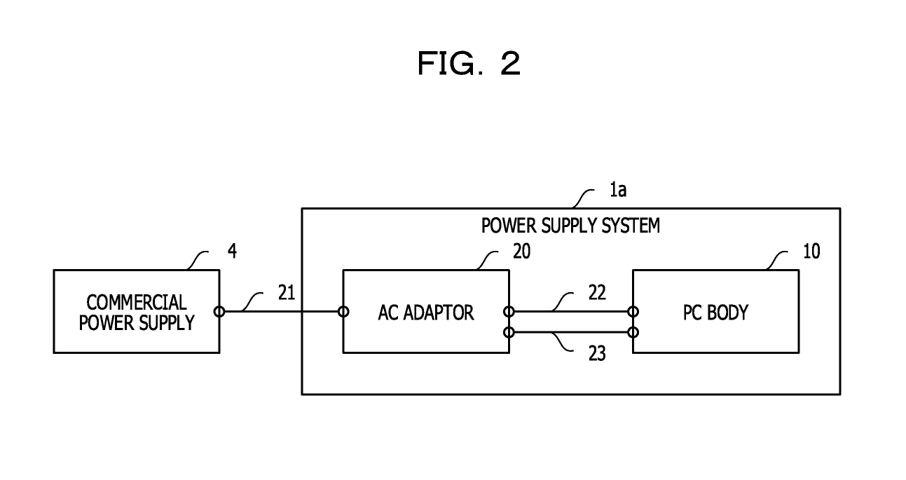

Next, a power supply system according to a second embodiment will be described with reference to FIG. 2. FIG. 2 is a diagram illustrating an example of a power supply system according to a second embodiment.

A power supply system 1a includes a PC body 10 and an AC adaptor 20. The AC adaptor 20 is a type of a power supply adaptor. The AC adaptor 20 is coupled to the commercial power supply 4 using a power line 21. The commercial power supply 4 is an AC power supply. The AC adaptor 20 converts the input alternating current into direct current (DC) and outputs the direct current. The AC adaptor 20 and the PC body 10 are coupled with each other through a power line 22 and a signal line 23. The AC adaptor 20 outputs alternating current to the power line 22 and receives an AC adaptor control signal from the signal line 23. The AC adaptor 20 changes the output voltage based on the AC adaptor control signal. The AC adaptor 20 includes an output capacitor having a large capacity in order to handle instantaneous interruption or an instantaneous drop that occurs in the commercial power supply. Examples of the output capacitor include an aluminum electrolytic capacitor, a solid capacitor, and the like. Accordingly, since the capacity of the output capacitor is large, the AC adaptor 20 has a bad response due to the voltage variation. The PC body 10 is a load unit serving as a load in the power supply system 1a, and consumes the power. The PC body 10 receives direct current from the power line 22 to drive the load unit and outputs the AC adaptor control signal according to a load from the signal line 23.

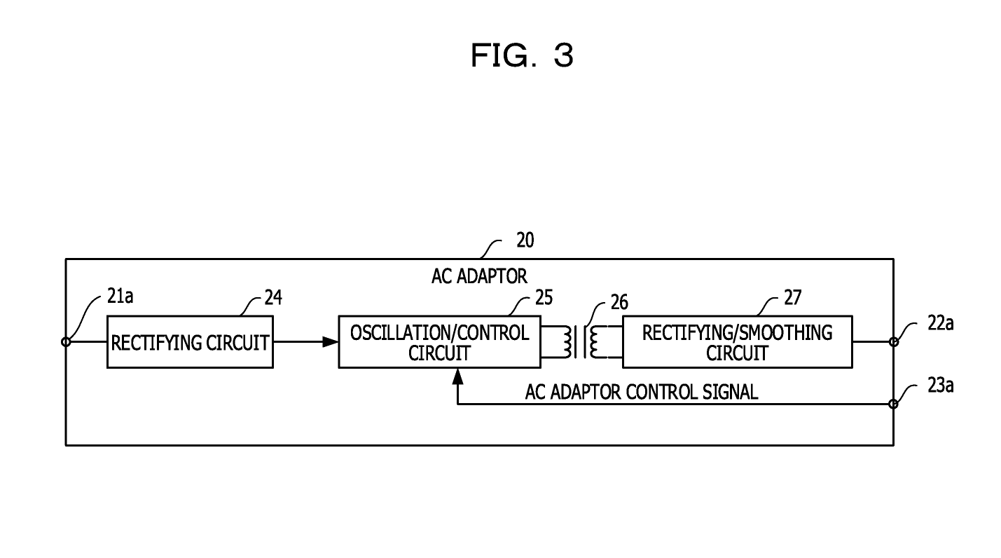

Next, a circuit configuration of an AC adaptor according to the second embodiment will be described with reference to FIG. 3. FIG. 3 is a diagram illustrating an example of a circuit configuration of an AC adaptor according to the second embodiment.

In the AC adaptor 20, alternating current (for example, AC 100 V) is input from an AC input unit 21a and direct current (for example, DC 7.5 V to 13 V) is output from a DC output unit 22a. In the AC adaptor 20, an AC adaptor control signal is input from a control signal input unit 23a.

The AC adaptor 20 includes a rectifying circuit 24, an oscillation/control circuit 25, a transformer 26, and a rectifying/smoothing circuit 27. The alternating current input from the AC input unit 21a is rectified by the rectifying circuit 24 and then is converted to high frequency alternating current by the oscillation/control circuit 25, is transformed by the transformer 26, is rectified and smoothed by the rectifying/smoothing circuit 27, and is output from the DC output unit 22a as DC.

The AC control signal input from the control signal input unit 23a is input to the oscillation/control circuit 25. The oscillation/control circuit 25 performs an output adjustment based on the AC control signal. With this, the AC adaptor 20 may change the AC voltage output from the DC output unit 22a.

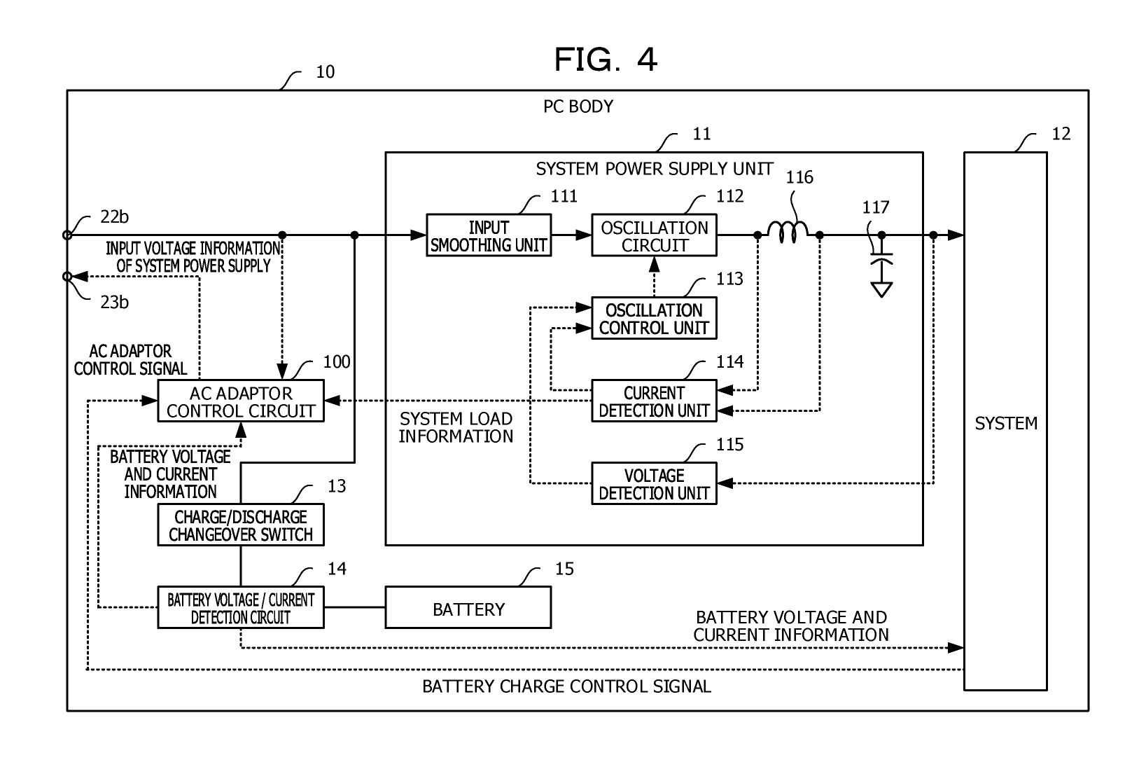

Next, a circuit configuration of a PC body according to the second embodiment will be described with reference to FIG. 4. FIG. 4 is a diagram illustrating an example of a circuit configuration of the PC body according to the second embodiment.

A PC body 10 includes a system power supply unit 11, a system 12, a charge/discharge changeover switch 13, a battery voltage/current detection circuit 14, a battery 15, and an AC adaptor control circuit 100. The system power supply unit 11 receives power supplied from the AC adaptor 20 or the battery 15 and generates power to be supplied to the system 12. The system power supply unit 11 may be a power supply unit that generates two or more different power supply voltages. The system 12 drives the system power supply unit 11 as a power supply. The system 12 includes, for example, a processor as a drive unit that consumes a large power in the PC body 10. The system power supply unit 11 and the system 12 consume power supplied from the AC adaptor 20 or the battery 15, and thus, serve as a load unit in the PC body 10 in a broad sense. The system 12 is a main unit that consumes power in the PC body 10, and thus, serves as a load unit (main load unit) in the PC body 10 in a narrow sense.

The load unit is arranged on a supply path to which the power is supplied from The AC adaptor 20 and the battery 15. In a case where a power consumption state is shifted by the load unit, a voltage or a current on a supply path to which the power is supplied from the AC adaptor 20 and the battery 15 is changed. For example, in a case where the system 12 transits from being in an idle state to being in an active state, power consumed by the system 12 is increased, and thus, the voltage on the supply path is decreased. In a case where the system 12 transits from being in an active state to being in an idle state, the power consumed by the system 12 is decreased, and thus, the voltage on the supply path is increased.

The system power supply unit 11 includes an input smoothing unit 111, an oscillation circuit 112, an oscillation control unit 113, a current detection unit 114, a voltage detection unit 115, a coil 116, and a capacitor 117. The system power supply unit 11 receives the power supplied from the DC input unit 22b or the battery 15. An input voltage is smoothed by the input smoothing unit 111. The oscillation circuit 112 transforms the voltage input from the input smoothing unit 111. The coil 116 and the capacitor 117 removes a pulsation component contained in the direct current output by the input smoothing unit 111, and then outputs the direct current to the system 12. The current detection unit 114 detects the current that flows in the coil 116, that is, a load current of the system 12 (system power supply load current). The voltage detection unit 115 detects the output voltage of the system power supply unit 11, that is, an input voltage of the system 12. The oscillation control unit 113 controls the oscillation circuit 112 by feeding back a current value detected by the current detection unit 114 or a voltage value detected by the voltage detection unit 115, or both of the current value and the voltage value.

The charge/discharge changeover switch 13 performs switching between charging and discharging of the battery 15. For example, the charge/discharge changeover switch 13 performs connection and disconnection of a route that connects the output of the AC adaptor 20 and the input of the battery 15, and performs connection and disconnection of a route that connects the output of the battery 15 and the input of the system power supply unit 11. The battery voltage/current detection circuit 14 detects the voltage (for example, charging voltage) and the current (for example, charging current) of the battery 15. The battery 15 is a secondary battery, for example, a lithium ion battery.

The AC adaptor control circuit 100 is a type of a power supply control device that outputs the AC adaptor control signal to control the AC adaptor 20. The AC adaptor control circuit 100 detects the voltage input to the system power supply unit 11. The voltage detected by the AC adaptor control circuit 100 is input to the AC adaptor control circuit 100 as input voltage information of system power supply. The AC adaptor control circuit 100 receives system load information output from the current detection unit 114, battery voltage and current information output from the battery voltage/current detection circuit 14, and a battery charge control signal output from the system 12 as inputs. The AC adaptor control circuit 100 receives the input voltage information of system power supply, the system load information, the battery voltage and current information, and the battery charge control signal as inputs, and generates the AC adaptor control signal using one or more of the information and the signal. The AC adaptor control circuit 100 outputs the AC adaptor control signal from the signal output unit 23b to control the AC adaptor 20.

The system load information is information generated based on the current value detected by the current detection unit 114 and information representing the load of the system 12. The battery voltage and current information is information generated based on the voltage value and the current value detected by the battery voltage/current detection circuit 14 and information representing the charge and discharge state of the battery 15. The battery charge control signal is a signal that causes a charge control of the battery 15. For example, the system 12 generates the battery charge control signal based on the battery voltage and current information so as to perform the charge control according to the amount of electricity accumulated in the battery 15.

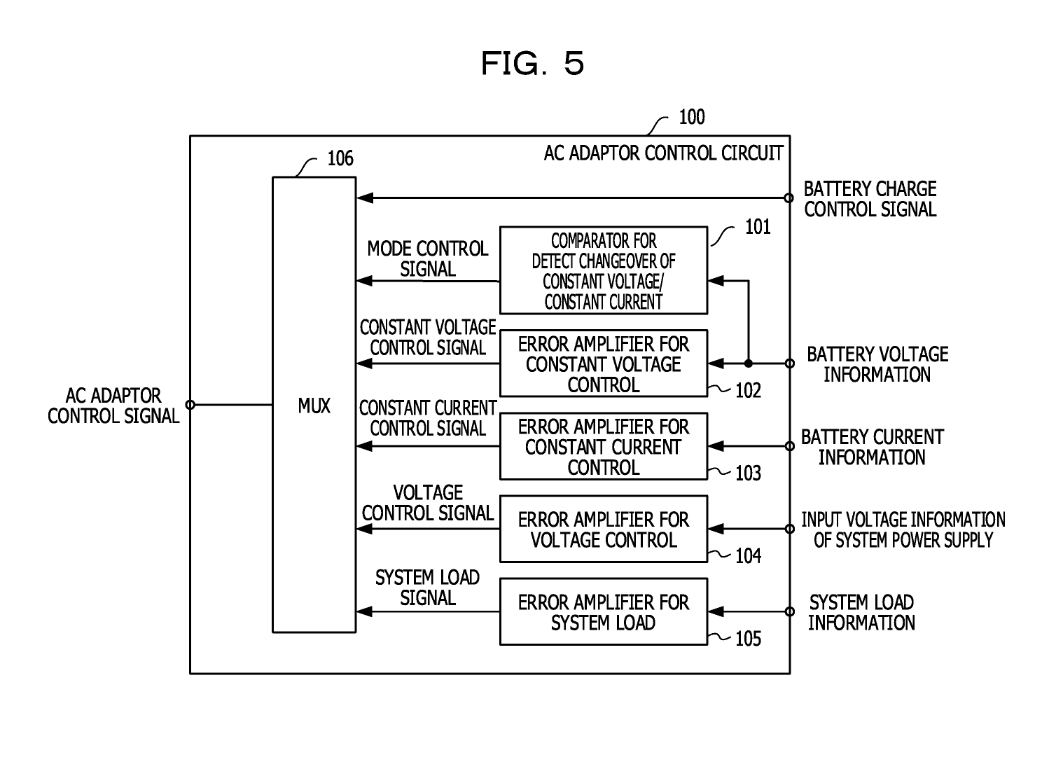

Next, a circuit configuration of the AC adaptor control circuit 100 according to the second embodiment will be described with reference to FIG. 5. FIG. 5 is a diagram illustrating an example of a circuit configuration of an AC adaptor control circuit according to the second embodiment.

The AC adaptor control circuit 100 includes a comparator for constant voltage/constant current changeover detection 101, an error amplifier for constant voltage control 102, an error amplifier for constant current control 103, an error amplifier for voltage control 104, an error amplifier for system load 105, and a MUX 106.

The MUX 106 receives a mode control signal for switching a constant voltage mode and a constant current mode from the comparator for constant voltage/constant current changeover detection 101 as an input. The comparator for constant voltage/constant current changeover detection 101 generates the mode control signal based on the battery voltage information of the battery voltage and current information output by the battery voltage/current detection circuit 14 and outputs the mode control signal. The mode control signal is a control signal for switching the constant voltage mode or the constant current mode. For example, the comparator for constant voltage/constant current changeover detection 101 generates a mode control signal which causes the constant voltage mode from the battery voltage information in a case where the voltage of the battery 15 is greater than or equal to a predetermined threshold value, and generates a mode control signal which causes the constant current mode in a case where the voltage of the battery 15 is less than the predetermined threshold value.

The error amplifier for constant voltage control 102 receives the battery voltage information of the battery voltage and current information as an input. The error amplifier for constant voltage control 102 generates a signal for a constant voltage control (constant voltage control signal) from the battery voltage information and outputs the signal. The error amplifier for constant current control 103 receives the battery current information of the battery voltage and current information as an input. The error amplifier for constant current control 103 generates a signal for a constant current control (constant current control signal) from the battery voltage information and outputs the signal. The error amplifier for voltage control 104 receives the input voltage information of system power supply as an input. The error amplifier for voltage control 104 generates a signal for a voltage control (system load signal) from the input voltage information of system power supply and outputs the signal. The error amplifier for system load 105 receives the system load information as an input. The error amplifier for system load 105 generates a signal for a voltage control (voltage control signal) from the system load information and outputs the signal.

The MUX 106 is a multiplexer, and receives the battery charge control signal, the mode control signal, the constant voltage control signal, the constant current control signal, the voltage control signal, and the system load signal as inputs. The MUX 106 generates the AC adaptor control signal based on the battery charge control signal, the mode control signal, the constant voltage control signal, the constant current control signal, the voltage control signal, and the system load signal, and outputs the AC adaptor control signal.

Specifically, the MUX 106 may detect whether or not the battery 15 is being charged from the battery charge control signal. In a case where the battery 15 is not being charged, the MUX 106 generates the AC adaptor control signal from the voltage control signal. The MUX 106 may detect the constant voltage mode and the constant current mode from the mode control signal.

In a case where the battery 15 is being charged and is in a constant voltage mode, the MUX 106 generates the AC adaptor control signal from the constant voltage control signal and the system load signal. For example, the MUX 106 generates the AC adaptor control signal by superposing the system load information on the constant voltage control signal. In a case where the battery 15 is being charged and is in a constant current mode, the MUX 106 generates the AC adaptor control signal from the constant current control signal and the system load signal. For example, the MUX 106 generates the AC adaptor control signal by superposing the system load information on the constant current control signal.

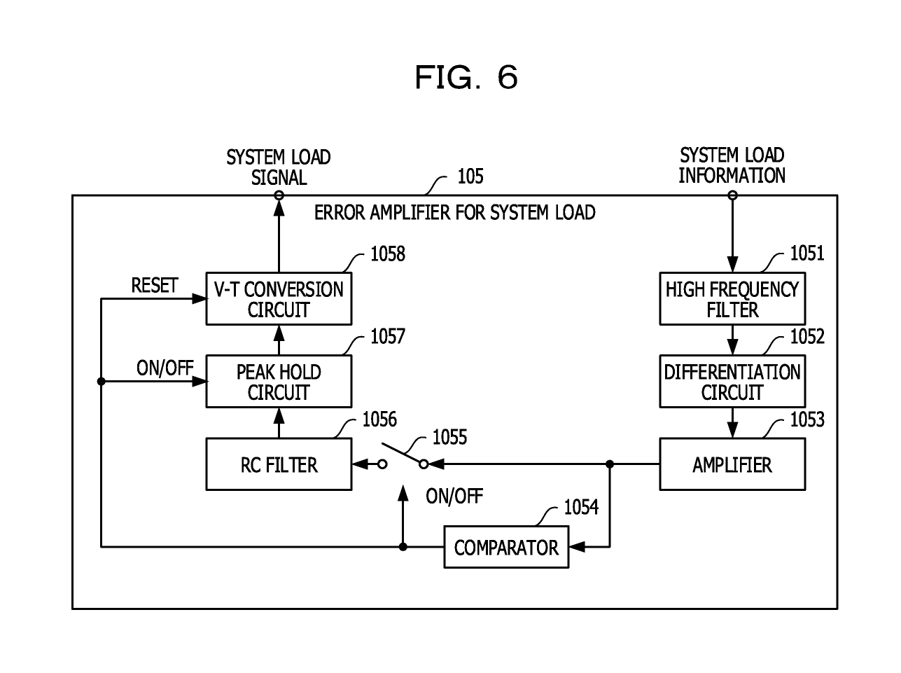

Next, a circuit configuration of the error amplifier for system load 105 according to the second embodiment will be described with reference to FIG. 6. FIG. 6 is a diagram illustrating an example of a circuit configuration of an error amplifier for system load according to the second embodiment.

The error amplifier for system load 105 includes a high frequency filter 1051, a differentiation circuit 1052, an amplifier 1053, a comparator 1054, a switch (SW) 1055, and an RC filter 1056. Furthermore, the error amplifier for system load 105 includes a peak hold circuit 1057 and a voltage-time period (V-T) conversion circuit 1058.

The high frequency filter 1051 removes high frequency noise from an input signal. The high frequency filter 1051 receives the system load information as an input and outputs the system load signal obtained by removing the high frequency noise. The system load information includes information of voltage change having a magnitude in proportion to a magnitude of the load current of the system power supply.

The differentiation circuit 1052 outputs a differential waveform of the input signal. The differentiation circuit 1052 receives the system load information in which the high frequency noise is removed by the high frequency filter 1051 as an input, and outputs the differential waveform. The differentiation circuit 1052 outputs the waveform having amplitude which is increased as the variation of system load information is increased and the variation becomes sharper.

The amplifier 1053 receives a signal output from the differentiation circuit 1052 as an input. The amplifier 1053 inverts the input signal and outputs a signal subjected to a gain adjustment. With this, the amplifier 1053 converts a change in the output voltage of the differentiation circuit to the negative direction into the positive direction thereof and easily controls the change in the battery charge voltage that occurs temporarily and to a large extent.

The comparator 1054 receives a signal output from the amplifier 1053 as an input. The comparator 1054 compares a voltage of the input signal and a threshold value and outputs a comparison result in a voltage level signal. The comparator 1054 outputs a low level voltage when the voltage of the input signal is less than the threshold value and outputs a high level voltage when the voltage of the input signal is greater than or equal to the threshold value.

The SW 1055 is controlled by a signal output from the comparator 1054. The SW 1055 is turned ON when the voltage of the signal output by the comparator 1054 is at a high level, and is turned OFF when the voltage of the signal output by the comparator 1054 is at a low level. With this, the SW 1055 restricts an input of signal from the amplifier 1053 to the RC filter 1056.

The RC filter 1056 receives a signal output of the amplifier 1053 which is restricted by the SW 1055 as an input. That is, the RC filter 1056 receives a signal output by the amplifier 1053 as an input when the voltage of the signal output by the comparator 1054 is a high level, and receives a low level voltage as an input when the voltage of the signal output by the comparator 1054 is a low level. The RC filter 1056 outputs a signal obtained by making the input signal weak.

The peak hold circuit 1057 outputs a signal obtained by holding a peak of the input signal. The peak hold circuit 1057 receives a signal output from the comparator 1054 as an input, and holds the peak of the voltage of the signal input from the RC filter 1056 when the signal output from the comparator 1054 is at a high level.

The V-T conversion circuit 1058 receives a signal output from the comparator 1054 as an input. The V-T conversion circuit 1058 is reset by an edge trigger by which the voltage output by the comparator 1054 is changed from a low level to a high level. The V-T conversion circuit 1058 outputs a predetermined voltage as a system load signal for a time period depending on the magnitude of the voltage from the resetting. The system load signal has a function of decreasing the output voltage of an AC adaptor when the system load signal is in a high level, and does not have a function of decreasing the output voltage of AC adaptor when the system load signal is at a low level.

By doing this, the error amplifier for system load 105 generates the system load signal from the input system load information and outputs the generated system load signal.

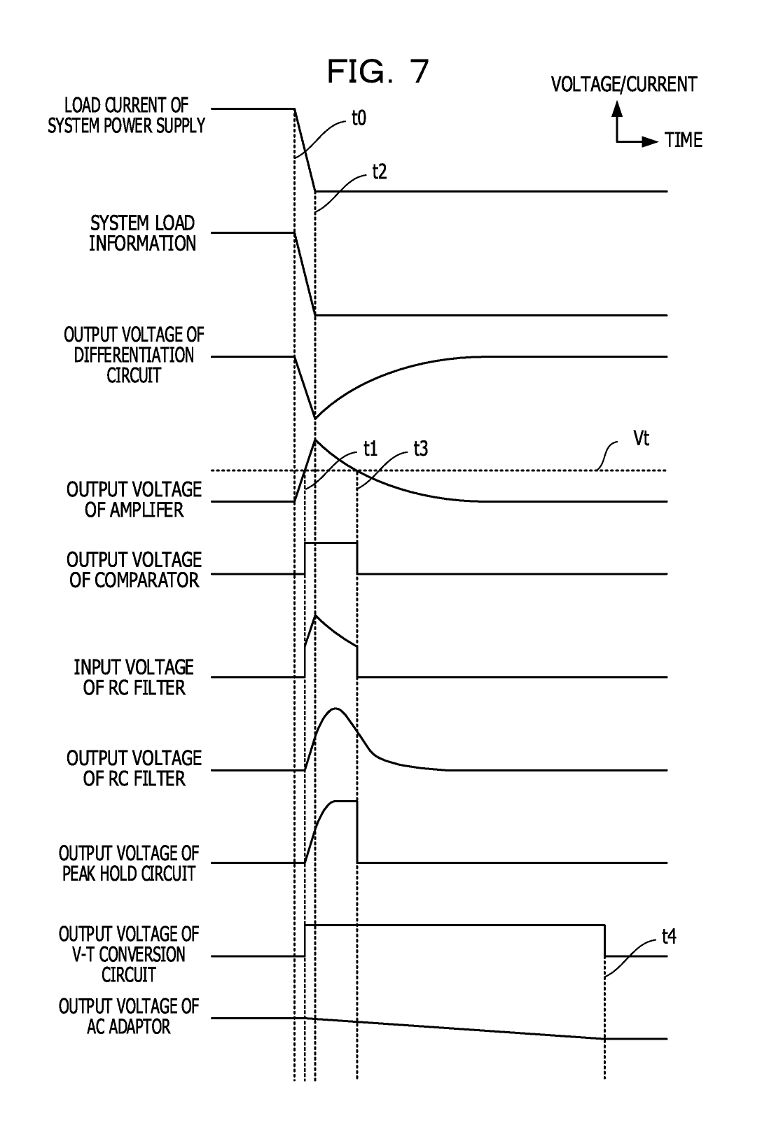

Next, a waveform in each circuit component in the error amplifier for system load 105 when the system load information which is suddenly changed with a large variation is input according to the second embodiment will be described with reference to FIG. 7. FIG. 7 is a diagram illustrating an example of an output waveform in each circuit component in an error amplifier for system load when the system load information which is suddenly changed with a large variation is input according to the second embodiment.

The load current of system power supply represents a waveform which is suddenly changed with a large variation from a timing t0 to a timing t2. The error amplifier for system load 105 receives the system load information which is suddenly changed with a large variation from the timing t0 to the timing t2 as well when the load current of system power supply is suddenly changed with a large variation from the timing t0 to the timing t2.

The differentiation circuit 1052 receives the system load information which is suddenly changed with a large variation from the timing t0 to the timing t2 as an input, and outputs a waveform that is suddenly changed with a large variation in the negative direction from the timing t0 to the timing t2 and then returns gently after the timing t2. The amplifier 1053 outputs a waveform obtained by taking the inverse of the output of the differentiation circuit.

The differentiation circuit 1052 may be realized by including, for example, a resistor and a capacitor, and may set detection characteristics of the variation of the system load information per time by a time constant.

The comparator 1054 receives an amplifier output voltage as an input. The comparator 1054 outputs a comparator output voltage which reaches a high level from a low level at a timing t1 at which the amplifier output voltage becomes greater than or equal to a threshold value Vt, and which reaches a low level from a high level at a timing t3 at which the amplifier output voltage becomes less than a threshold value Vt.

The RC filter 1056 receives the amplifier output voltage from the timing t1 to the timing t3 as an input, as represented by an RC filter input voltage, and a low level voltage is input at other timings. The RC filter 1056 outputs a waveform obtained by making the input signal of the RC filter weak, as represented by an RC filter output voltage.

The peak hold circuit 1057 outputs an output voltage of the peak hold circuit obtained by holding a peak of the output voltage of the RC filter from the timing t1 to the timing t3. The V-T conversion circuit 1058 is reset at the timing t1 and outputs the output voltage of V-T conversion circuit as the system load signal from the timing t1 to a timing t4.

The system load signal is one of signals input to the MUX 106 and generates the AC adaptor control signal. The AC adaptor control signal is generated based on the system load signal. The AC adaptor control signal, which is generated based on the load current of the system power supply which is suddenly changed with a large variation, may decrease the output voltage of the AC adaptor based on the system load signal from the timing t1 and the timing t4.

As described above, the system load signal includes information about timing at which the output voltage of the AC adaptor is decreased depending on a timing at which a level of the system load signal is changed from a low level to a high level. The system load signal includes information about a voltage magnitude with which the output voltage of AC adaptor is reduced depending on the threshold value Vt.

With this, the AC adaptor control circuit 100 may perform a power supply control by the system load signal while performing either a constant voltage control based on the constant voltage control signal or a constant current control based on the constant current control signal. The AC adaptor control circuit 100 may stably control the output voltage of the AC adaptor by the power supply control described above.

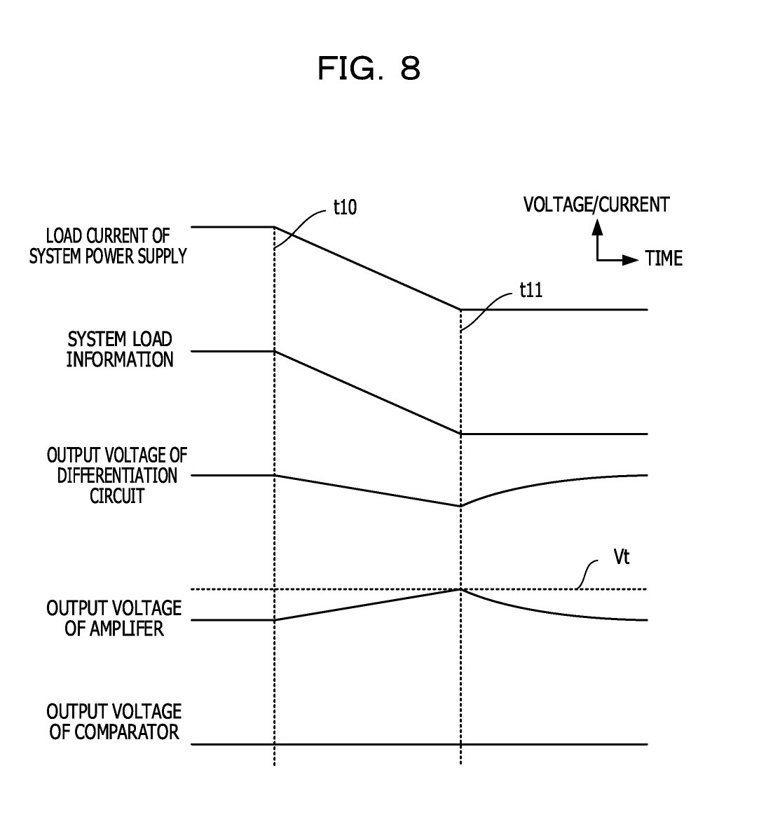

Next, a waveform in each circuit component in the error amplifier for system load 105 when the system load information which is gently changed with a large variation is input according to the second embodiment will be described with reference to FIG. 8. FIG. 8 is a diagram illustrating an example of an output waveform in each circuit component in an error amplifier for system load when the system load information which is gently changed with a large variation is input according to the second embodiment.

The load current of system power supply represents a waveform which is gently changed with a large variation from timing t10 to timing t11. The error amplifier for system load 105 receives the system load information which is gently changed with a large variation from timing t10 to timing t11 as well when the load current of system power supply is gently changed with a large variation from timing t10 to timing t11.

The differentiation circuit 1052 receives the system load information which is gently changed with a large variation from timing t10 to timing t11 as an input, and outputs a waveform that is gently changed with a large variation in the negative direction from timing t10 to timing t11 and is gently returned after timing t11. The amplifier 1053 outputs a signal obtained by inversing an output voltage of the differentiation circuit.

The comparator 1054 receives an amplifier output voltage as an input, and outputs a comparator output voltage which becomes a low level because the amplifier output voltage is less than the threshold value Vt.

With this, the RC filter 1056, the peak hold circuit 1057, and the V-T conversion circuit 1058 receive a low level signal as an input and the AC adaptor control circuit 100 outputs the low level signal as the system load signal.

Accordingly, in a case where the amplifier output having a gentle change becomes less than the threshold value Vt, even if the variation of the system load signal is large, the AC adaptor control circuit 100 performs constant voltage control based on the constant voltage control signal, and performs constant current control based on the constant current control signal.

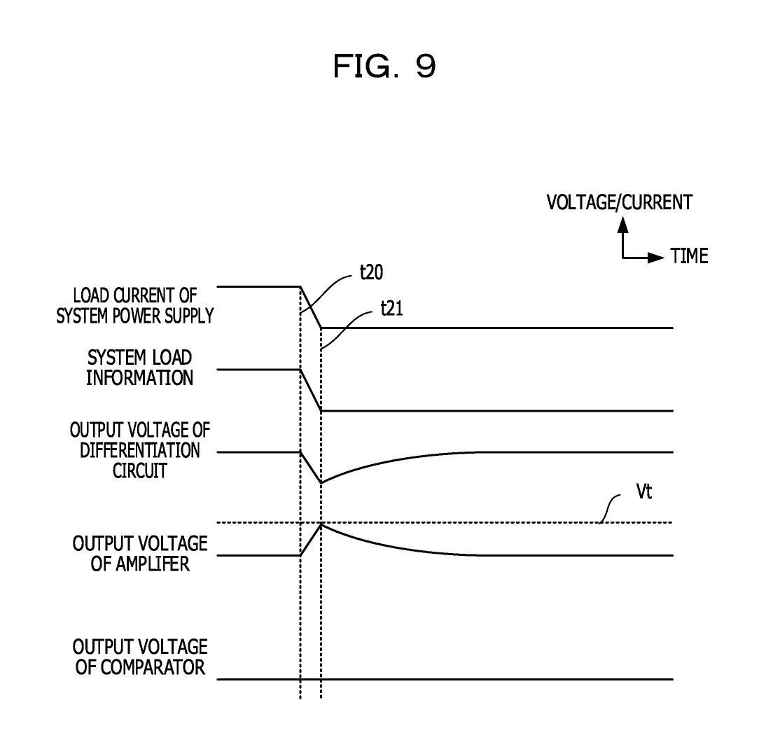

Next, a waveform in each circuit component in the error amplifier for system load 105 when the system load information which is suddenly changed with a small variation is input according to the second embodiment will be described with reference to FIG. 9. FIG. 9 is a diagram illustrating an example of an output waveform in each circuit component in an error amplifier for system load when the system load information which is suddenly changed with a small variation is input according to the second embodiment.

The load current of system power supply represents a waveform which is suddenly changed with a small variation from a timing t20 to a timing t21. The error amplifier for system load 105 receives the system load information which is suddenly changed with a small variation from the timing t20 to the timing t21, as well when the load current of system power supply is suddenly changed with a small variation from the timing t20 to the timing t21.

The differentiation circuit 1052 receives the system load information which is suddenly changed with a small variation from the timing t20 to the timing t21 as an input, and outputs a waveform that is suddenly changed with a small variation in the negative direction from the timing t20 to the timing t21, and then returns gently after the timing t21. The amplifier 1053 outputs a waveform obtained by inversing an output voltage of the differentiation circuit.

The comparator 1054 receives an amplifier output voltage as an input, and outputs a comparator output voltage which becomes a low level because the amplifier output voltage is less than the threshold value Vt.

With this, the RC filter 1056, the peak hold circuit 1057, and the V-T conversion circuit 1058 receive the low level signal as an input and the AC adaptor control circuit 100 outputs the low level signal as the system load signal.

Accordingly, in a case where the amplifier output having a small variation becomes less than the threshold value Vt, even if the variation of the system load signal is suddenly changed, the AC adaptor control circuit 100 performs constant voltage control based on the constant voltage control signal and performs constant current control based on the constant current control signal.

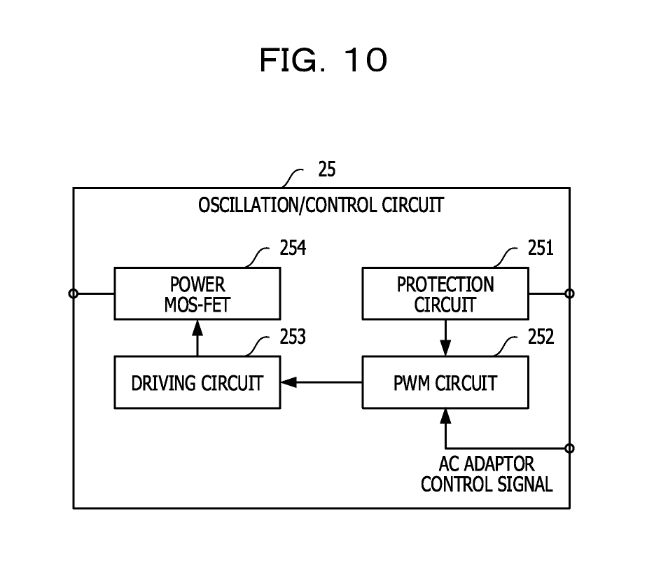

Next, a circuit configuration of the oscillation/control circuit 25 provided in the AC adaptor according to the second embodiment will be described with reference to FIG. 10. FIG. 10 is a diagram illustrating an example of a circuit configuration of an oscillation/control circuit provided in the AC adaptor according to the second embodiment.

The oscillation/control circuit 25 includes a protection circuit 251, a pulse width modulation (PWM) circuit 252, a driving circuit 253, and a power metal-oxide-semiconductor field-effect transistor (MOS-FET) 254.

The protection circuit 251 receives an output from the rectifying circuit 24 as an input and protects the oscillation/control circuit 25 from an overvoltage or a rush current. The PWM circuit 252 receives an output from the protection circuit 251 and the AC adaptor control signal as inputs, performs pulse width modulation according to information about the control timing and the control amount contained in the AC adaptor control signal, and outputs the signal to the driving circuit 253. The driving circuit 253 drives the Power MOS-FET 254 according to the control signal input from the PWM circuit 252. The Power MOS-FET 254 performs switching according to the signal input from the driving circuit 253.

With this, the AC adaptor 20 may control the output voltage of AC adaptor based on the AC adaptor control signal output by the PC body 10. The AC adaptor 20 performs the constant voltage control for the output voltage of AC adaptor by the AC adaptor control signal based on the constant voltage control signal. The AC adaptor 20 performs the constant current control for the output voltage of AC adaptor by the AC adaptor control signal based on the constant current control signal. The AC adaptor 20 performs the voltage control for the output voltage of AC adaptor by the AC adaptor control signal based on the voltage control signal. Additionally, the AC adaptor 20 may perform a power supply control, by which the output voltage of AC adaptor may be directly changed according to the load, by the AC adaptor control signal based on the system load signal.

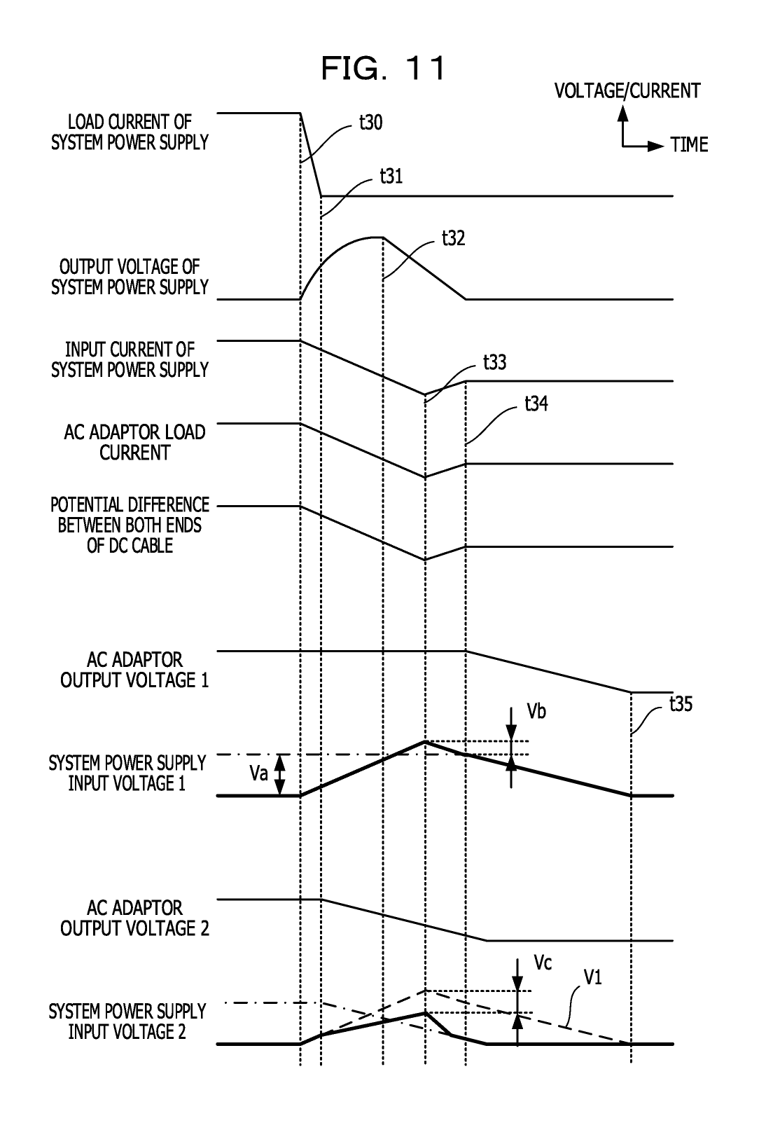

Next, an effect of the system load information contributing to the output voltage of AC adaptor and the input voltage of system power supply according to the second embodiment will be described with reference to FIG. 11. FIG. 11 is a diagram illustrating comparison examples for cases of the presence or absence of the system load information for a waveform of an output voltage of AC adaptor, and a waveform of an input voltage of the system power supply.

The load current of system power supply represents a waveform which is suddenly changed with a large variation from a timing t30 to a timing t31. In this case, the output voltage of system power supply is subjected to overshooting at a timing t32 due to a delay of the load response. The input current of system power supply is subjected to undershooting, which is behind the overshoot of the output voltage of system power supply, at a timing t33 due to a reverse flow of charge of the output voltage of system power supply. The AC adaptor load current becomes substantially the same waveform as that of the input current of system power supply, and a magnitude of the potential difference between both ends of the DC cable (power line 22) becomes proportional to the AC adaptor load current.

In this case, in a case where the output voltage of AC adaptor is controlled without reflecting the system load information, the output voltage of AC adaptor is changed like a waveform illustrated in output voltage 1 of an AC adaptor. Such an output waveform results from control that feeds back the input voltage of system power supply, and contains a voltage change in a direction in which the potential difference between both ends of the DC cable is cancelled.

With this, input voltage 1 of system power supply becomes a waveform (illustrated in bold line) obtained by lowering output voltage 1 of an AC adaptor by the potential difference between both ends of the DC cable. According to this, the input voltage 1 of system power supply is increased by (Va+Vb) from a factor including a load response delay and undershooting of the input current of the system power supply.

Such a voltage increase is applied to the battery 15 when the battery 15 is charged and is deviated from a voltage range permitted under the change control, for example, an overvoltage may be applied to the battery 15. Accordingly, the load imposed on the battery 15 at the time of charging is large in such a control of the output voltage of AC adaptor.

The input voltage 1 of system power supply returns to a stationary voltage having a time lag up to a timing t35. Such a large time lag may cause the charge control of the battery 15 to be ineffective.

In the meantime, in a case where the output voltage of AC adaptor is controlled by reflecting the system load information, the waveform of the output voltage of AC adaptor is changed like a waveform illustrated in output voltage 2 of AC adaptor. The output voltage 2 of AC adaptor is reduced from timing t31 due to the reflection of the system load information.

With this, input voltage 2 of system power becomes the waveform (illustrated in bold line) obtained by lowering the output voltage 2 of AC adaptor by a potential difference between both ends of the DC cable. According to this, the input voltage 2 of system power supply is increased, but becomes smaller compared to the input voltage 1 of system power supply from the factor which includes a delay of load response and undershooting in the input current of the system power supply. For example, the input voltage 2 of system power supply suppresses the voltage increase by Vc further than the input voltage 1 of system power supply illustrated as dotted line V1.

Such a suppression of voltage increase contributes to the improvement in accuracy of an application voltage in the charge control of the battery 15. Accordingly, such control of the output voltage of AC adaptor may make a response of voltage variation imposed on the battery 15 faster and reduce the load which occurs due to the voltage variation.

The input voltage 2 of system power supply returns to a stationary voltage by shortening the time lag which the input voltage 1 of system power supply has. Such a shortening of the time lag contributes to efficient charge control of the battery 15.

The PC body 10 is an example of an electronic apparatus which becomes a load unit. For example, the PC body 10 frequently switches between an idle state and an active state at high speed or the like, and the variation width of the system load is large and abrupt. Further, the variation width of the system load and abruptness of the change will tend to progress more remarkably in improvement of the system response and reduction of the size and weight of the electronic apparatus in the future. The power supply system 1a may perform the charge control by reducing the load of the battery provided in the electronic apparatus. The power supply system 1a may efficiently perform the charge control by reducing the load of the battery provided in the electronic apparatus.

In general, it is desirable to limit design conditions in order to optimize the power supply from the viewpoint of conversion efficiency or the like. Since the power supply system 1a may suppress the variation width of the input voltage, the power supply system 1a easily optimizes the power supply unit by limiting the design conditions.

Although the power supply system 1a notifies the AC adaptor control signal from the PC body 10 to the AC adaptor 20 by the analog signal of voltage level, the AC adaptor control signal may be notified from the PC body 10 to the AC adaptor 20 by command communication.

In the second embodiment, the power supply system 1a includes the AC adaptor 20 which converts DC-AC conversion as a type of the power supply adaptor. However, in a case where the input power supply is DC power supply, the power supply system 1a may include a DC-DC converter instead of the AC adaptor 20. In this case, the DC-DC converter is a type of the power supply adaptor.

The power supply system 1a detects the output load of the system power supply unit 11 as the magnitude of the output current, but is not limited thereto and may receive notification of the load information from the system 12. For example, the AC adaptor control circuit 100 may receive notification of the information about the power consumption or the driving quantity from the processor provided in the system 12. According to this, the power supply system is may perform control having a time lag which is smaller than the measurement and detection time of the output load.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An electronic apparatus comprising:
a battery that is charged with power supplied from a power supply adaptor;
a load unit that is arranged on a supply path through which power is supplied from the power supply adaptor and the battery; and
a power supply control unit that detects a load of the load unit and output a control signal which causes the power supply adaptor to change an output voltage based on the load.

2. The electronic apparatus according to claim 1, further comprising:
a power supply unit that generates power to be supplied to the load unit from the power supplied from the power supply adaptor or the battery,
wherein the power supply control unit detects the load based on a change in current or a change in voltage input from the power supply unit to the load unit.

3. The electronic apparatus according to claim 2, wherein
the power supply control unit detects the load from a current or a voltage, which is input to a processor provided in the load unit, of currents or voltages input from the power supply unit to the load unit.

4. The electronic apparatus according to claim 1, wherein
the power supply control unit generates the control signal when the battery is being charged.

5. The electronic apparatus according to claim 1, wherein
the power supply control unit generates the control signal in a case where a variation per time of the load exceeds a predetermined threshold.

6. The electronic apparatus according to claim 1, wherein
the power supply control unit generates the control signal from a first signal which causes the power supply adaptor to change an output voltage based on the voltage or the current of the battery and a second signal which causes the power supply adaptor to change an output voltage based on the load.

7. A power supply control device which performs power supply control of an electronic apparatus including a battery that is charged with power supplied from a power supply adaptor and a load unit that is arranged on a supply path through which power is supplied from the power supply adaptor and the battery,
wherein the power supply control device detects a load of the load unit and output a control signal which causes the power supply adaptor to change an output voltage based on the load.

8. A power supply system comprising:
a power supply adaptor that converts an alternating current to a direct current; and
an electronic apparatus capable of being electrically coupled to the power supply adaptor, the electronic apparatus including a battery that is charged with power supplied from the power supply adaptor,
a load unit that is arranged on a supply path through which power is supplied from the a power supply adaptor and the battery, and
a power supply control unit that detects a load of the load unit and output a control signal which causes the power supply adaptor to change an output voltage based on the load,
wherein the power supply adaptor includes an output voltage change unit which changes an output voltage based on the control signal.
